(19) United States
(12) Patent Application Publication
(10) Pub. No.: US 2020/0269506 A1
(43) Pub. Date: Aug. 27, 2020

(54) APPARATUSES, SYSTEMS, AND METHODS FOR PERFORMING THREE-DIMENSIONAL CALIBRATION FOR ADDITIVE MANUFACTURING

(71) Applicant: MARKFORGED, INC., Watertown, MA (US)

(72) Inventors: Angus MACMULLEN, Cambridge, MA (US); Andrew CARLSON, Cambridge, MA (US); David LAWRENCE, Cambridge, MA (US); Jonathan Bond, Melrose, MA (US)

(21) Appl. No.: 16/286,290

(22) Filed: Feb. 26, 2019

(51) Int. Cl. B29C 64/314; B29C 64/209

(52) U.S. Cl. CPC B29C 64/314; B33Y 10/00; B29C 64/209

(57) ABSTRACT

Apparatuses, systems, and methods for determining a position of a nozzle of a 3D printer are described. In certain implementations, a method for determining a position of a nozzle of a 3D printer is provided. The method includes moving a nozzle assembly relative to a test feature of a calibration object such that a nozzle tip contacts the test feature for a plurality of times. The nozzle assembly includes the nozzle that has the nozzle tip. The method also includes reading positions of the nozzle when the nozzle tip contacts the test feature. The method further includes determining a relative position of an end point of the nozzle relative to a reference point.

### BACKGROUND

### Technical Field

The present disclosure generally relates to the field of additive manufacturing, including apparatuses, systems, and methods for performing additive manufacturing. More particularly, and without limitation, the disclosed embodiments relate to, among other things, apparatuses, systems, and methods for performing three-dimensional calibration for additive manufacturing.

### Background Description

Additive manufacturing refers to any one of various manufacturing technologies that build objects in an additive, typically layer-by-layer, fashion. Additive manufacturing is also referred to by the general public as “3D printing.” One type of the additive manufacturing technologies is based on extrusion deposition, such as fused deposition modeling (FDM) or fused filament fabrication (FFF). Over the last few years FDM or FFF has become a commonly used technology for modeling, prototyping, and production. In FDM or FFF, filament of a 3D printing material is extruded through a nozzle installed on a moving, heated print head, and is deposited on a print bed or the object being printed. The print head and/or the print bed can move in three dimensions relative to each other under computer control to define the printed object. For example, the print head can move in two dimensions to deposit one horizontal plane or a layer of the object at a time. Then, the print head or the print bed can be moved vertically by a small amount to begin a new layer of the object. In 3D printing, such as FDM or FFF, accurate controlling, gauging, and calibrating the position of the nozzle is beneficial for creating reliable and accurate printed objects. The present disclosure provides, among other things, apparatuses, systems, and methods for determining and calibrating the position of the nozzle for 3D printing.

### SUMMARY

The embodiments of the present disclosure provide apparatuses, systems, and methods for performing three-dimensional calibration for 3D printing. Advantageously, the exemplary embodiments allow for automatic and accurate determination and calibration of the position of at least one nozzle of a 3D printer in three dimensions.

According to an exemplary embodiment of the present disclosure, a nozzle assembly for depositing a material for forming an object is described. The nozzle assembly includes a nozzle having a nozzle tip to deposit the material. The nozzle assembly further includes a sensor at least partially attached to the nozzle. The sensor is configured to detect a contact between the nozzle tip and a surface.

According to another exemplary embodiment of the present disclosure, a print head for a 3D printer is described. The print head includes a nozzle assembly for depositing a material for forming an object. The nozzle assembly includes a nozzle having a nozzle tip to deposit the material. The nozzle assembly further includes a sensor at least partially attached to the nozzle. The sensor is configured to detect a contact between the nozzle tip and a surface.

According to another exemplary embodiment of the present disclosure, a 3D printer is described. The 3D printer includes a print head, a print bed, and a positioning instrument. The print head includes at least one nozzle assembly for depositing a material for forming an object. The at least one nozzle assembly includes a nozzle having a nozzle tip to deposit the material. The at least one nozzle assembly further includes a sensor at least partially attached to the nozzle. The sensor is configured to detect a contact between the nozzle tip and a surface. The positioning instrument is configured to move the print head and the print bed relative to each other vertically and/or horizontally.

According to another exemplary embodiment of the present disclosure, a method for determining a position of a nozzle of a 3D printer is described. The method includes moving a nozzle assembly and a surface relative to each other. The nozzle assembly includes the nozzle and a sensor at least partially attached to the nozzle. The nozzle includes a nozzle tip. The method includes detecting, by the sensor, a contact between the surface and the nozzle tip. The method also includes reading, by a positioning instrument, a vertical position of the nozzle upon contacting the surface. The method further includes determining a vertical position of an end point of the nozzle.

According to another exemplary embodiment of the present disclosure, a method for determining a position of a nozzle of a 3D printer is described. The method includes moving a nozzle assembly relative to a test feature of a calibration object such that a nozzle tip contacts the test feature for a plurality of times. The nozzle assembly includes the nozzle that has the nozzle tip. The method also includes reading positions of the nozzle when the nozzle tip contacts the test feature. The method further includes determining a relative position of an end point of the nozzle relative to a reference point.

According to another exemplary embodiment of the present disclosure, a method for 3D printing an object is described. The method includes determining an offset of a nozzle having a nozzle tip. The method includes moving the nozzle assembly relative to a test feature of a calibration object such that the nozzle tip contacts the test feature for a plurality of times. The nozzle assembly includes the nozzle. The method further includes reading positions of the nozzle when the nozzle tip contacts the test feature. The method further includes determining the offset of the nozzle based on the read positions. The method further includes calibrating a position of the nozzle based on the offset. The method further includes printing the object.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of certain disclosed embodiments as set forth in the accompanying claims.

### BRIEF DESCRIPTION OF DRAWINGS

FIG. 1 illustrates an exemplary 3D printer, according to some embodiments of the present disclosure.

FIG. 2A illustrates an exemplary nozzle of a 3D printer, according to some embodiments of the present disclosure.

FIG. 2B illustrates another exemplary nozzle of a 3D printer, according to some embodiments of the present disclosure.

FIG. 3A illustrates relative vertical movement between an exemplary nozzle and an exemplary object, according to some embodiments of the present disclosure.

FIG. 3B illustrates relative vertical movement between an exemplary nozzle and an exemplary object, according to some embodiments of the present disclosure.

FIG. 3C illustrates relative vertical movement and/or contact between an exemplary nozzle and an exemplary object, according to some embodiments of the present disclosure.

FIG. 4 illustrates an exemplary nozzle assembly, according to some embodiments of the present disclosure.

FIG. 5 illustrates an exemplary nozzle assembly, according to some embodiments of the present disclosure.

FIG. 6A illustrates an exemplary nozzle assembly and an exemplary object, according to some embodiments of the present disclosure.

FIG. 6B illustrates detection of a contact between a nozzle of the exemplary nozzle assembly of FIG. 6A and an exemplary object, according to some embodiments of the present disclosure.

FIG. 7A illustrates an exemplary nozzle assembly and an exemplary object, according to some embodiments of the present disclosure.

FIG. 7B illustrates detection of a contact between a nozzle of the exemplary nozzle assembly of FIG. 7A and an exemplary object, according to some embodiments of the present disclosure.

FIG. 8A illustrates relative movement and contacts between an exemplary nozzle and an exemplary object, according to some embodiments of the present disclosure.

FIG. 8B illustrates an exemplary linear relationship between the vertical position and the horizontal position of the exemplary nozzle of FIG. 8A, according to some embodiments of the present disclosure.

FIG. 9A illustrates relative movement and contacts between an exemplary nozzle and an exemplary object, according to some embodiments of the present disclosure.

FIG. 9B illustrates an exemplary linear relationship between the vertical position and the horizontal position of the exemplary nozzle of FIG. 9A, according to some embodiments of the present disclosure.

FIG. 10A illustrates relative movement and contacts between an exemplary nozzle and an exemplary object, according to some embodiments of the present disclosure.

FIG. 10B illustrates an exemplary linear relationship between the vertical position and the horizontal position of the exemplary nozzle of FIG. 10A, according to some embodiments of the present disclosure.

FIG. 11 illustrates an exemplary object, according to some embodiments of the present disclosure.

FIG. 12A illustrates an exemplary contact between an exemplary nozzle tip and an exemplary test feature, according to some embodiments of the present disclosure.

FIG. 12B illustrates exemplary Z-axis positions of an exemplary nozzle when the nozzle tip makes a series of contacts with the exemplary test feature of FIG. 12A at different X-axis positions, according to some embodiments of the present disclosure.

FIG. 12C illustrates exemplary Z-axis positions of an exemplary nozzle when the nozzle tip makes a series of contacts with the exemplary test feature of FIG. 12A at different Y-axis positions, according to some embodiments of the present disclosure.

FIG. 13A illustrates an exemplary contact between an exemplary nozzle tip and an exemplary test feature, according to some embodiments of the present disclosure.

FIG. 13B illustrates exemplary Z-axis positions of an exemplary nozzle when the nozzle tip makes a series of contacts with the exemplary test feature of FIG. 13A at different X-axis positions, according to some embodiments of the present disclosure.

FIG. 13C illustrates exemplary Z-axis positions of an exemplary nozzle when the nozzle tip makes a series of contacts with the exemplary test feature of FIG. 13A at different Y-axis positions, according to some embodiments of the present disclosure.

FIG. 14A illustrates an exemplary contact between an exemplary nozzle tip and an exemplary test feature, according to some embodiments of the present disclosure.

FIG. 14B illustrates exemplary Z-axis positions of an exemplary nozzle when the nozzle tip makes a series of contacts with the exemplary test feature of FIG. 14A at different X-axis positions, according to some embodiments of the present disclosure.

FIG. 14C illustrates exemplary Z-axis positions of an exemplary nozzle when the nozzle tip makes a series of contacts with the exemplary test feature of FIG. 14A at different Y-axis positions, according to some embodiments of the present disclosure.

FIG. 15 illustrates another exemplary testing object, according to some embodiments of the present disclosure.

FIG. 16A illustrates an exemplary nozzle making a pair of contacts with an exemplary test feature, according to some embodiments of the present disclosure.

FIG. 16B illustrates an exemplary nozzle making a pair of contacts with an exemplary test feature, according to some embodiments of the present disclosure.

FIG. 16C illustrates an exemplary nozzle making a pair of contacts with an exemplary test feature, according to some embodiments of the present disclosure.

FIG. 17A illustrates two exemplary linear relationships between a pair of Z-axis positions and the X-axis position of an exemplary nozzle making a series of pairs of contacts with an exemplary test feature, according to some embodiments of the present disclosure.

FIG. 17B illustrates two exemplary linear relationships between a pair of Z-axis positions and the Y-axis position of an exemplary nozzle making a series of pairs of contacts with an exemplary test feature, according to some embodiments of the present disclosure.

FIG. 18 is a flowchart of an exemplary method for determining a position of a nozzle of a 3D printer, according to some embodiments of the present disclosure.

FIG. 19 is a flowchart of an exemplary method for determining a position of a nozzle of a 3D printer, according to some embodiments of the present disclosure.

FIG. 20 is a flowchart of an exemplary method for 3D printing an object, according to some embodiments of the present disclosure.

### DETAILED DESCRIPTION

The disclosed embodiments relate to, among other things, apparatuses, systems, and methods for performing three-dimensional calibration for 3D printing. Embodiments of the present disclosure may be implemented in any 3D printing systems or devices built according to certain embodiments of the present disclosure.

In 3D printing, such as FDM or FFF, to improve the accuracy and consistency of the printed object, an offset between a position of an end point of a nozzle of a 3D printer and a position of the nozzle read by a positioning instrument needs to be determined. A calibration of the position of the nozzle may be performed based on the determined offset. For example, the calibration may include adjustment of the position of the nozzle and/or tuning of the positioning instrument to correlate the readings of the positioning instrument with the position of the end point of the nozzle. If the nozzle is not calibrated, the printed object may not have the correct dimension, may not adhere to the print bed, or may have other undesirable defects.

For example, a vertical offset of the nozzle that is not calibrated affects the thickness of the first layer of the object being printed, which in turn affects the adhesion of the object to the print bed. For example, a vertical offset of a nozzle can cause the end point of the nozzle to be too close to the print bed such that the first layer can be distorted or too thin, resulting in defective printing. On the other hand, a vertical offset of the nozzle can cause the end point of the nozzle to be too far away from the print bed such that the first layer does not adhere well to the print bed, or that the first layer becomes too thick, causing the object to become warped or to detach from the print bed. Therefore, it is beneficial to accurately determine the vertical offset of the nozzle so as to calibrate the position of the nozzle and obtain a desired thickness of the first layer.

Additionally, when multiple nozzles of a 3D printer are used to deposit different materials to print an object, the alignment of the different materials can be affected by the relative vertical and horizontal positions of the multiple nozzles. For example, a vertical offset between two nozzles that are not calibrated can cause two layers of two different materials deposited by the two nozzles to have different heights. For another example, a horizontal offset between two nozzles that are not calibrated can cause two different materials on the same layer to disconnect or to overlap, failing the print or generating a defect in the printed object.

Some methods for detecting and calibrating the vertical offset of the nozzle of a 3D printer use proxy sensors located near the nozzle, such as microswitches, capacitive sensors, inductive sensors, and optical sensors. However, such sensors have an offset from the position of the end point of the nozzle. This offset needs to be accurately determined by independent, and potentially non-accurate, means to derive the position of the end point of the nozzle. Other methods use sensors that can detect the contact of the nozzle with the print bed or an object being printed, such as electrical conductive sensors and piezoelectric sensors. However, the use of electrical conductive sensors is limited to prints using electrically conductive printer components, such as nozzles and print beds. Also, to use a piezoelectric sensor to detect the contact of the nozzle to the print bed or an object being printed, high deflection or high acceleration of the nozzle is needed. In addition to having reduced accuracy and precision, such high deflection or high acceleration of the nozzle can cause damage to the tip of the nozzle and/or the object being printed. Piezoelectric sensors are also temperature-sensitive and can render inaccurate results when used with a heated print head, a heated print bed, or a heated enclosure.

Embodiments of the present disclosure provide apparatuses, systems, and methods for accurately determining the position of an end point of at least one nozzle of a 3D printing system in three dimensions. The determination of the position of the end point of the at least one nozzle allows for determination of the offset of the at least one nozzle in three dimensions and calibration of the position of the at least one nozzle in three dimensions. Advantageously, embodiments of the present disclosure allow for accurate and automated control of the thickness of the first layer and alignment of different materials deposited by different nozzles.

In some instances, a position of a nozzle refers to the position of an end point of the nozzle where a printing material is extruded relative to an origin. Determining a position of a nozzle refers to determining the position of the end point of the nozzle. Calibrating a position of a nozzle refers to calibrating the position of the end point of the nozzle. In other instances, a position of a nozzle refers to the position of the nozzle read by a positioning instrument. An origin, for example, refers to any fixed point of reference. In some instances, the origin is the zero point of a positioning instrument. In some instances, the origin is a fixed point in a standard three-dimensional coordinate system of a 3D printer, such as an origin of a Cartesian coordinate system or an origin of a polar coordinate system. In a Cartesian coordinate system, a vertical position of a nozzle refers to the position of the nozzle along the Z-axis. A horizontal position of a nozzle refers to the position of the nozzle along the X-axis, the position of the nozzle along the Y-axis, or the position of the nozzle on a plane defined by the X-axis and the Y-axis. As described herein, embodiments of the present disclosure described herein with reference to a Cartesian coordinate system are equally applicable to 3D printing systems using a polar coordinate system or any other suitable three-dimensional coordinate system.

As used herein, an offset of a nozzle refers to a difference between the position of the nozzle read by a positioning instrument and a position of the end point of the nozzle relative to the origin. A vertical offset of a nozzle refers to an offset of the nozzle in the vertical dimension. A horizontal offset of a nozzle refers to an offset of the nozzle in the horizontal dimension. A nozzle may have an offset in the vertical dimension, in the horizontal dimension, or in both the vertical and horizontal dimensions. In a Cartesian coordinate system, an X-axis offset refers to an offset along the X-axis. A Y-axis offset refers to an offset along the Y-axis. A horizontal offset refers to an offset along the X-axis, the Y-axis, or an offset on a plane defined by the X-axis and the Y-axis. A Z-axis offset or a vertical offset refers to an offset along the Z-axis.

According to one aspect of the present disclosure, embodiments of the present disclosure allow for determining a vertical position of an end point of a nozzle by bringing a nozzle assembly and a surface towards each other and detecting a contact between a nozzle tip of the nozzle and a surface. The surface may be the surface of a print bed, the surface of a layer of an object being printed, or the slope of multiple printed layers. In some embodiments, the nozzle assembly includes a sensor. In some embodiments, a part, a section, or an element of the sensor is attached or coupled to the nozzle. As used herein, a nozzle tip refers to a distal end of a nozzle having an opening at the end point for extruding a printing material.

In some embodiments, detecting the contact between the nozzle tip and the surface includes detecting a displacement of the nozzle tip upon contacting the surface and using the displacement of the nozzle tip to determine the vertical position of the nozzle. In some embodiments, determining the vertical position of the end point of the nozzle allows for determining a vertical offset of the nozzle and calibrating the vertical position of the nozzle based on the vertical offset.

According to another aspect of the present disclosure, embodiments of the present disclosure allow for determining a horizontal position of an end point of a nozzle by moving the nozzle assembly relative to a test feature such that the nozzle tip contacts the test feature for a plurality of times. In some embodiments, determining the horizontal position of an end point of the nozzle includes reading the vertical and horizontal positions of the nozzle when the nozzle tip contacts the test feature and determining a horizontal position of the end point of the nozzle based on the read vertical and horizontal positions of the nozzle and a determined vertical position of the end point of the nozzle.

In some embodiments, the test feature is an integral part of a print bed. For example, the test feature can be a recess, a protrusion, or an edge of the print bed. In some embodiments, the test feature has a symmetric cross section along which a nozzle moves and contacts. In some embodiments, the test feature has a non-symmetric cross section along which a nozzle moves and contacts. The test feature may include a recess or a protrusion that include one or more slopes and/or one or more edges. In some embodiments, the test feature is a geometric feature of a calibration object. The calibration object can be removably or fixedly attached to the print bed of a 3D printer. In some embodiments, the calibration object is printed by a nozzle of the 3D printer.

According to another aspect of the present disclosure, embodiments of the present disclosure allow for determining a relative offset between the end point of a first nozzle and the end point a second nozzle by determining positions of the end point of the first nozzle and the end point of the second nozzle relative to a reference point. As used herein, a reference point refers to a fixed point of a test feature or a fixed point in the coordinate system of a 3D printer. In some embodiments, a first nozzle assembly having a first nozzle is moved relative to a test feature such that the nozzle tip of the first nozzle contacts the test feature for a plurality of times. A position of the end point of the first nozzle relative to the reference point can be determined based on readings of the vertical and horizontal positions of the first nozzle when the nozzle tip contacts the test feature. A position of the end point of the second nozzle relative to the reference point can be similarly determined. Using the positions of the end points of the first nozzle and the second nozzle relative to the reference point, a relative offset between the end points of the first nozzle and the second nozzle can be determined. In some embodiments, the position of at least one of the end points of the first nozzle and second nozzle is calibrated based on the relative offset. In some embodiments, embodiments of the present disclosure allow for determining relative offsets between the end points of three or more nozzles by determining the positions of the end points of the nozzles relative to a reference point.

Advantageously, embodiments of the present disclosure do not require subjective observation from a user, such as visual inspection of a printed part or tactile inspection with physical shims. Embodiments of the present disclose do not require manual adjustment of the position of a nozzle or a nozzle assembly. Embodiments of the present disclosure provide automated determination of the position of a nozzle and its offset in three dimensions, allowing for accurate calibration of the position of the nozzle and improving the success rate and/or quality of prints of a 3D printer. Additionally, unlike other position sensing methods described above, embodiments of the present disclosure obtain the position of a nozzle by using the nozzle itself to directly detect the position of the nozzle and do not require separate knowledge of the relative position between the nozzle and the location of a proxy sensor, which could introduce errors for determining the position of the nozzle.

Reference will now be made in detail to embodiments and aspects of the present disclosure, certain examples of which are illustrated in the accompanying drawings. Where possible, the same reference numbers will be used throughout the drawings to refer to the same or like parts.

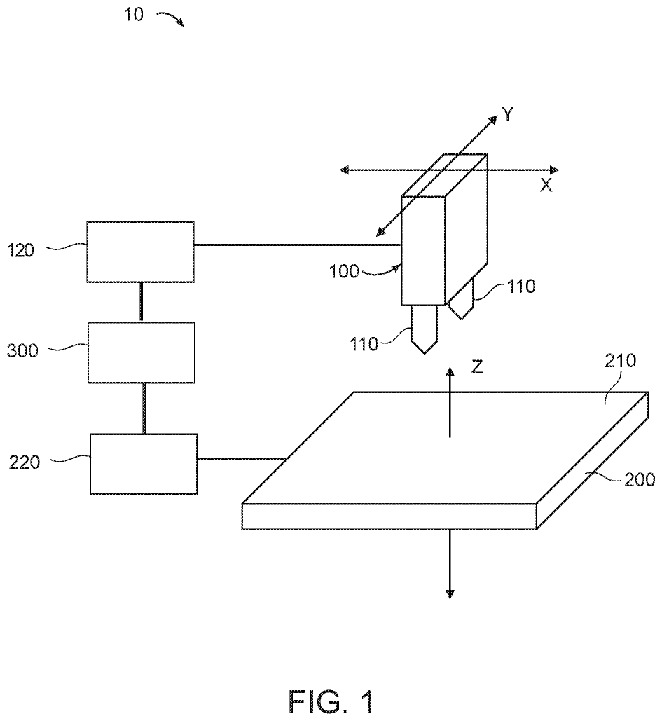

FIG. 1 illustrates an exemplary 3D printer 10, according to some embodiments of the present disclosure. 3D printer 10 includes a print head 100 and a print bed 200. Print head 100 includes one or more nozzles 110 for extruding or depositing one or more printing materials to build an object on a surface 210 of print bed 200. 3D printer 10 includes at least one positioning instrument for moving print head 100 and print bed 200 relative to each other in three dimensions. For example, 3D printer 10 may include a first positioning instrument 120 for moving print head 100 relative to print bed 200 in three dimensions. Positioning instrument 120 may provide a reading of the position of print head 100 and/or readings of the positions of nozzles 110 in three dimensions, e.g., along the X, Y, Z-axes. 3D printer 10 may include a second positioning instrument 220 for moving print bed 200 relative to print head 100 in the vertical dimension. Positioning instrument 220 may provide a reading of the position of print bed 200 in the vertical dimension, e.g., along the Z-axis. A positioning instrument may include one or more actuators, such as stepper motors, piezoelectric motors, belt driver motors, brushed DC motors, or brushless motors. In some embodiments, a positioning instrument may include one or more encoders for providing a reading of a position.

In some embodiments, 3D printer 10 includes a controller 300 for controlling the operation of the positioning instruments. For example, controller 300 may have a processor and a computer-readable medium that stores instructions or operational steps. These instructions or operational steps, when executed by the processor, may operate the positioning instruments of 3D printer 10 to move print head 100 and/or print bed 200 relative to each other in one or more dimensions. These instructions or operational steps, when executed by the processor, may further record the positions of nozzles 110 and/or of print bed 200 read by the positioning instruments. The recorded positions of nozzles 110 and/or of the print bed 200 can be saved in and retrieved from a non-transitory storage medium.

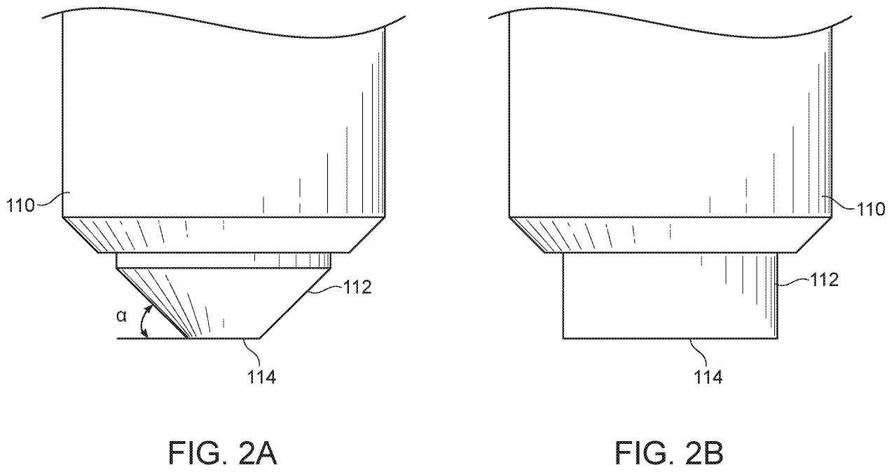

FIGS. 2A and 2B illustrates two exemplary nozzles 110, according to some embodiments of the present disclosure. As shown in FIGS. 2A and 2B, a nozzle 110 includes a nozzle tip 112. Nozzle tip 112 has an end point 114 where a printing material is extruded or deposited. Nozzle tip 112 can have any shape and size suitable for a particular print. In some embodiments, nozzle tip 112 has a symmetric shape. As a non-limiting example, as shown in FIG. 2A, nozzle tip 112 has a tapered shape with a tapered surface. In some embodiments, the tapered surface has a tilt angle α of about 45 degrees. As another non-limiting example, as shown in FIG. 2B, nozzle tip 112 has a cylindrical shape with a straight surface and a flat end.

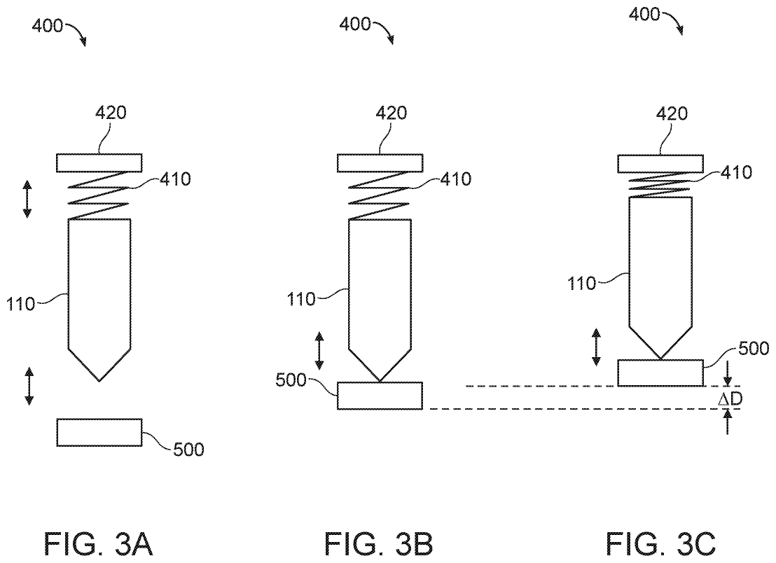

In some embodiments, a nozzle 110 of 3D printer 10 is part of a nozzle assembly. FIGS. 3A-3C illustrates an exemplary nozzle assembly 400 and relative vertical movement between an exemplary nozzle 110 and an exemplary object 500, according to some embodiments of the present disclosure. As shown in FIGS. 3A-3C, nozzle assembly 400 includes nozzle 110, a resilient member 410, and an rigid member 420. Rigid member 420 may be a rigid mechanical structure of print head 100. Resilient member 410 is attached to nozzle 110 at one end and attached to rigid member 420 at the other end. Resilient member 410 can be any suitable resilient device configured to allow nozzle 110 to deflect when nozzle tip 112 contacts a surface, such as surface 210 or a surface of object 500. For example, resilient member 410 can be a spring made of a metal coil or heat-resistant plastic material. The shape and the thickness of the resilient member can be designed and changed to obtain a consistent displacement from a relaxed state as shown in FIG. 3B to a compressed state as shown in FIG. 3C when nozzle tip 112 contacts a surface.

### Determination of the Vertical Position of the End Point of a Nozzle

To determine a vertical position of the end point 114 of nozzle 110, in some embodiments, nozzle assembly 400 and object 500 are moved towards each other such that nozzle tip 112 contacts a surface of object 500. Alternatively, nozzle assembly 400 and surface 210 can be moved towards each other such that nozzle tip 112 contacts surface 210. As described herein, embodiments of the present disclosure described below for detecting a contact between nozzle tip 112 and object 500 is equally applicable for detecting a contact between nozzle tip 112 and surface 210.

In some embodiments, the contact between nozzle tip 112 and object 500 can be detected by detecting a deflection of nozzle tip 112 or displacement of resilient member 410 upon the contact. For example, as shown in FIGS. 3B and 3C, the contact between nozzle tip 112 and object 500 can cause nozzle 110 to deflect from object 500 towards rigid member 420 and can cause resilient member 410 to displace from an extended state to a compressed state. Detecting the distance of deflection of nozzle 110, shown as AD in FIG. 3C, allows for detecting the contact between nozzle tip 112 and object 500.

For example, nozzle assembly 400 can be vertically moved towards object 500 by positioning instrument 120 of 3D printer 10. During the movement, the vertical positions of nozzle 110 of nozzle assembly 400 can be read by positioning instrument 120. When nozzle tip 112 comes to contact with object 500, it deflects and a detection signal is generated by a sensor of nozzle assembly 400. The detection signal indicates the contact of nozzle tip 112 and object 500. In some embodiments, nozzle assembly 400 and 3D printer 10 are configured to allow nozzle 10 to deflect for a consistent distance AD upon contacting object 500. For example, movement of nozzle 110 relative to object 500 can be stopped by controller 300 upon receiving the detection signal. Such feedback control allows nozzle 110 to deflect over a consistent distance AD when making contacts with object 500. As illustrated in FIGS. 3B and 3C, the vertical position of the end point of nozzle tip 112 where nozzle tip 112 first contacts object 500 (as shown in FIG. 3B) can be determined from the reading of the vertical position of nozzle 110 compensating for the distance of deflection AD of the nozzle.

In some embodiments, the determined vertical position of the end point of nozzle 110 is used as a reference point for further movements of nozzle 110. In some embodiments, a vertical offset of nozzle 110 can be determined by comparing the vertical position of the end point of nozzle 110 and a reading of the vertical position of nozzle 110 by positioning instrument 120. In some embodiments, the position of nozzle 110 in the vertical dimension can be calibrated based on the vertical offset of nozzle 110. In some instances, the position of nozzle 110 may be adjusted by the amount of the vertical offset. In other instances, positioning instrument 120 or 220 may be adjusted by the amount of the vertical offset to match its reading with the position of the end point of nozzle 110.

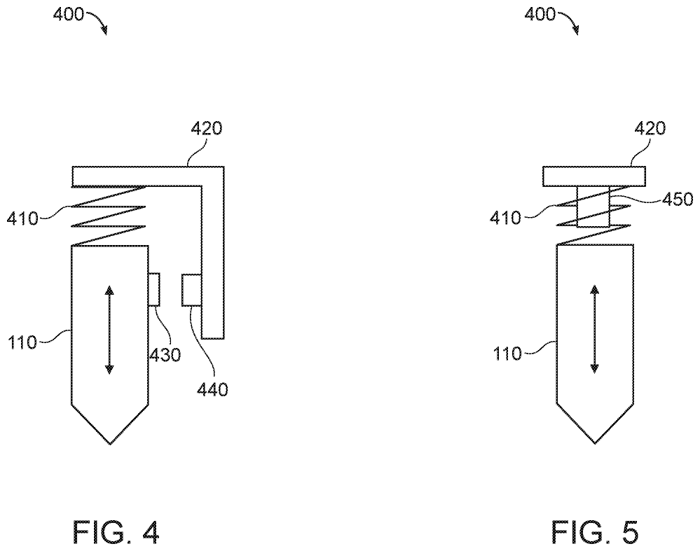

Various sensors can be used for detecting the deflection of nozzle 110 and/or the displacement of resilient member 410 and thereby detecting the contact between nozzle tip 112 and object 500. FIGS. 4-7B illustrates exemplary nozzle assemblies 400 that use different sensors to detect the deflection of nozzle 110, according to some embodiments of the present disclosure. In some embodiments, as shown in FIG. 4, nozzle assembly 400 includes a movement sensor having a first sensing element 430 and a second sensing element 440. First sensing element 430 is attached to nozzle 110. Second sensing element 440 is attached to rigid member 420. First sensing element 430 and/or second sensing element 440 can be operatively connected to controller 300 of 3D printer 10. Controller 300 may control the operation of first sensing element 430 and/or second sensing element 440 and may receive a detection signal generated by first sensing element 430 or second sensing element 440.

As shown in FIG. 4, vertical movement of nozzle 110 causes vertical movement of first sensing element 430 and thus relative vertical movement between first sensing element 430 and second sensing element 440. In some embodiments, second sensing element 440 detects the relative movement of first sensing element 430 and generates a detection signal indicative of the movement of first sensing element 430, which indicates the movement of nozzle 110 and a contact between nozzle tip 112 and object 500. First sensing element 430 and second sensing element 440 can be any suitable sensing devices that can detect a relative movement. In some embodiments, first sensing element 430 is a light source, such as an LED, and second sensing element 440 is an optical sensor, such as a photodiode light detector. In other embodiments, first sensing element 430 is a magnet and second sensing element 440 is a magnetic encoder.

FIG. 5 illustrates another exemplary nozzle assembly 400, according to some embodiments of the present disclosure. As shown in FIG. 5, in some embodiments, nozzle assembly 400 includes a sensor switch 450 attached to rigid member 420. Sensor switch 450 can be operatively connected to controller 300 of 3D printer 10. Controller 300 may control the operation of sensor switch 450 and may receive a detection signal from sensor switch 450. As illustrated in FIG. 5, vertical movement of nozzle 110 towards rigid member 420 can cause nozzle 110 to touch and actuate sensor switch 450. The actuation of sensor switch 450 generates a detection signal indicative of the movement of nozzle 110, which indicates a contact between nozzle tip 112 and object 500. Sensor switch 450 can be any suitable device that makes or breaks an electrical connection upon actuation by a mechanical contact, a movement, or the existence or absence of an optical signal. For example, sensor switch 450 can be a mechanical switch, a magnetic switch, or an optical switch.

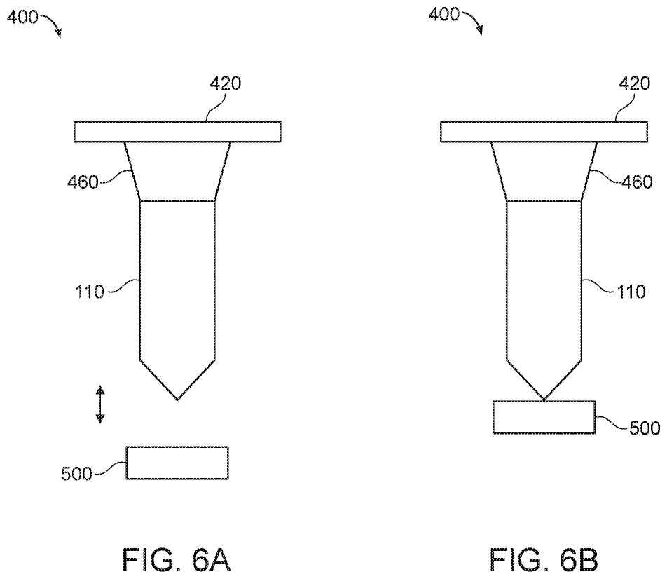

FIGS. 6A and 6B illustrate another exemplary nozzle assembly 400, according to some embodiments of the present disclosure. As shown in FIG. 6A, in some embodiments, nozzle assembly 400 includes a force sensor 460 between nozzle 110 and rigid member 420. Force sensor 460 can be operatively connected to controller 300 of 3D printer 10. Controller 300 may control the operation of force sensor 460 and may receive a detection signal from force sensor 460. As illustrated in FIGS. 6A and 6B, when nozzle 110 comes into contact with object 500, force sensor 460 can detect a force, pressure, or mechanical stress generated by nozzle 110 that is pushed against force sensor 460 upon and/or after the contact. Force sensor 460 then generates a detection signal indicative of the contact between nozzle tip 112 and object 500. Force sensor 460 can be any suitable device that responds to the applied force, pressure, or mechanical stress, such as a force-sensitive resistor.

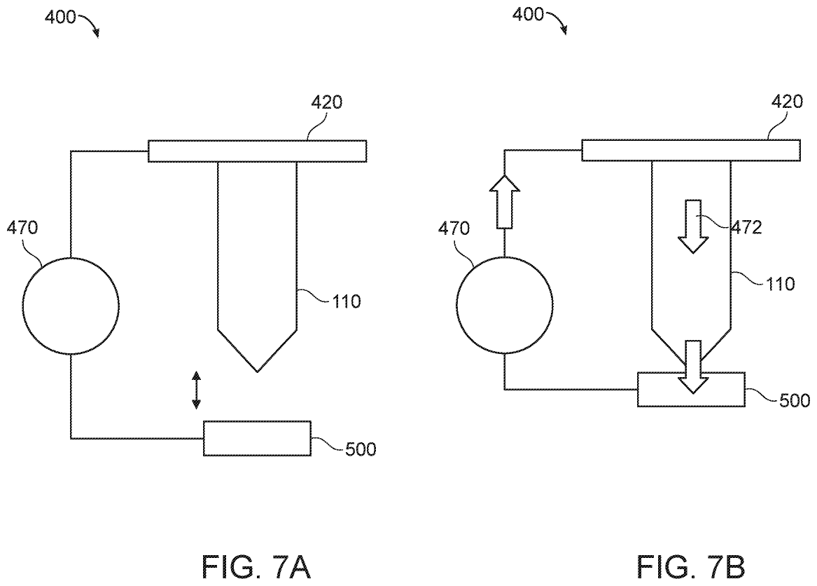

FIGS. 7A and 7B illustrate another exemplary nozzle assembly 400, according to some embodiments of the present disclosure. As shown in FIGS. 7A and 7B, in some embodiments, nozzle assembly 400 includes an electrical conductivity sensor 470 that is electrically connected to nozzle 110 and object 500. When both nozzle 110 and object 500 are electrically conductive, a contact between nozzle 110 and object 500 allows an electric current 472 to flow through in an electric circuit formed by nozzle 110, object 500, electrical conductively sensor 470, and any other suitable electrical components, including a current source. Electrical conductivity sensor 470 can be operatively connected to controller 300 of 3D printer 10. Controller 300 may control the operation of electrical conductivity sensor 470 and may receive a detection signal from electrical conductivity sensor 470.

### Determination of the Horizontal Position of the End Point of a Nozzle First Exemplary Scenario

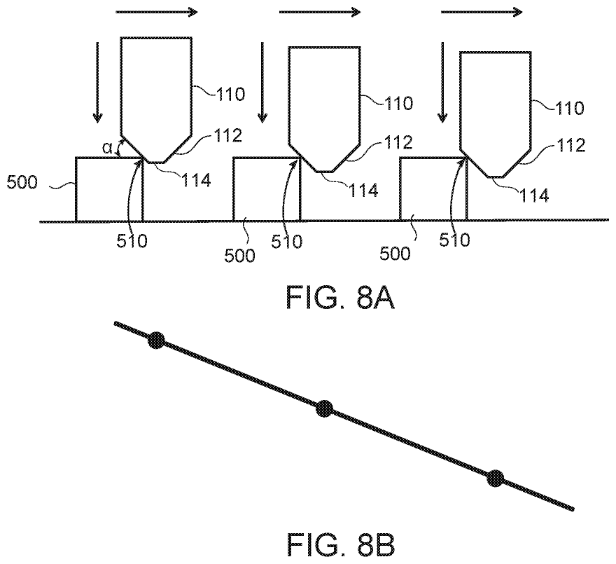

In some embodiments, to determine a horizontal position of the end point of nozzle 110, an association between the vertical position and horizontal position of the end point of nozzle 110 is obtained. The association is correlated with the geometric shape of nozzle tip 112 and/or the geometric shape of a test feature of object 500. In some embodiments, the association is a non-linear relationship, such as a parabolic relationship, a logarithmic relationship, or a stepwise relationship. In some embodiments, the association is a linear relationship. Using the association, the horizontal position of the end point of nozzle 110 can be determined based on the vertical position of the end point of nozzle 110 determined according to the embodiments described above. FIGS. 8A-10B illustrate determination of exemplary linear relationships between the vertical position and horizontal position of the end point of an exemplary nozzle.

In some embodiments, as shown in FIG. 8A, nozzle tip 112 has a tapered surface having a tilt angle α. Object 500 has an edge 510 as a test feature. When nozzle 110 is moved relative to object 500 horizontally, the vertical position of the end point 114 of nozzle 110 when nozzle tip 112 contacts edge 510 can change. For example, as shown in FIG. 8A, due to the tilt angle α of the tapered surface of nozzle tip 112, the vertical position of the end point 114 of nozzle 110 when nozzle tip 112 contacts edge 510 decreases in proportion with the change of the horizontal position of the end point 114 of nozzle 110 to the right. Thus, as illustrated in FIG. 8B, a linear relationship between the vertical position and the horizontal position of the end point 114 of nozzle 110 can be obtained by performing linear interpolation using the readings of the vertical positions and horizontal positions of nozzle 110 when nozzle tip 112 contacts edge 510. The slope of the linear relationship corresponds to the tilt angle α of the tapered surface of nozzle tip 112. Given a vertical position of the end point 114 of nozzle 110, the horizontal position of the end point 114 of nozzle 110 can be determined using the linear relationship.

As used herein, a linear relationship between the vertical position and the horizontal position of the end point 114 of nozzle 110 refers to an approximate direct proportionality between the vertical position and the horizontal position of the end point 114 of nozzle 110 when nozzle tip 112 moves across a test feature of object 500.

In some embodiments, the determined horizontal position of the end point 114 of nozzle 110 is used as a reference point for further movements of nozzle 110. In some embodiments, a horizontal offset of nozzle 110 can be determined by comparing the horizontal position of the end point 114 of nozzle 110 and a reference point, such as an origin. In some embodiments, the position of nozzle 110 in the horizontal dimension can be calibrated based on the horizontal offset of nozzle 110. In some instances, the position of nozzle 110 may be adjusted by the amount of the horizontal offset. In other instances, positioning instrument 120 or 220 may be adjusted by the amount of the horizontal offset to match its reading with the position of the end point 114 of nozzle 110.

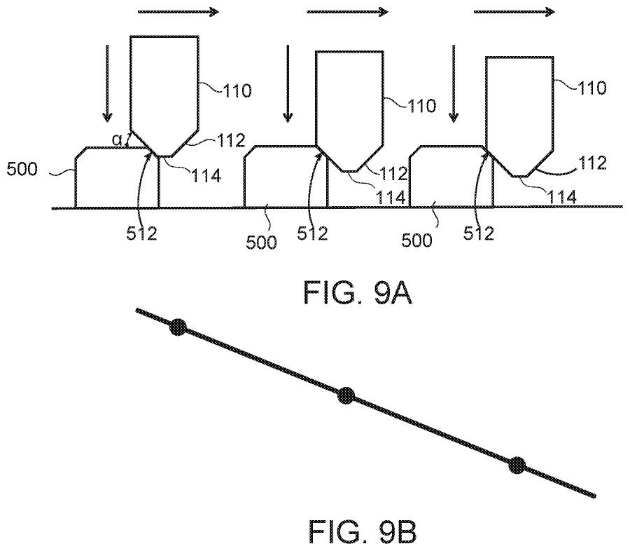

In some embodiments, as shown in FIG. 9A, object 500 has a chamfered edge 512. In some embodiments, chamfered edge 512 has an angle equal to the tilt angle of the tapered surface of nozzle tip 112. The matching of the angles of the chamfered edge and the tapered surface of nozzle tip 112 increases the contact area and reduces the contact pressure between object 500 and nozzle tip 112. This advantageously reduces the amount of deformation of object 500 when nozzle tip 112 comes into contact with object 500. Similarly, as illustrated in FIG. 9B, a linear relationship between the vertical position and the horizontal position of the end point 114 of nozzle 110 can be obtained by performing linear interpolation using the readings of the vertical positions and horizontal positions of nozzle 110 when nozzle tip 112 contacts edge 510.

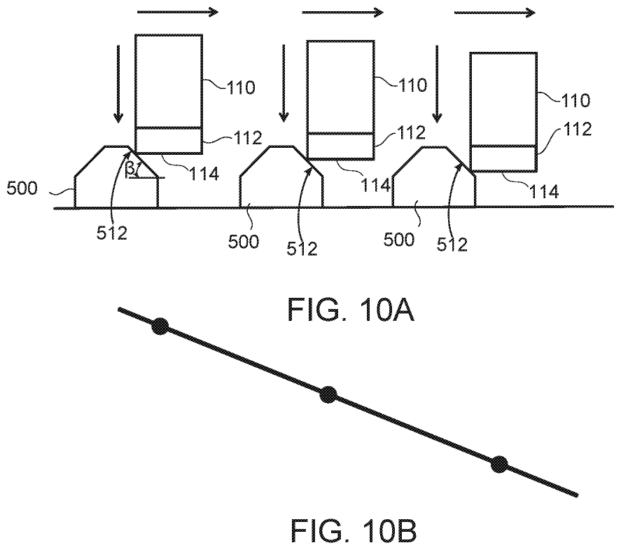

In some embodiments, as shown in FIG. 10A, nozzle tip 112 has a straight surface and a flat end. When nozzle assembly 400 is moved relative to chamfered edge 512 of object 500 horizontally, the edge of nozzle tip 112 can contact object 500 at different locations along the sloped surface of chamfered edge 512 having a tilt angle β. Thus, the vertical position of the end point 114 of nozzle 110 when nozzle tip 112 contacts chamfered edge 512 decreases in proportion with the change of the horizontal position of the end point 114 of nozzle 110 to the right. Similarly, as illustrated in FIG. 10B, a linear relationship between the vertical position and the horizontal position of the end point 114 of nozzle 110 can be obtained by performing linear interpolation using the readings of the vertical positions and horizontal positions of nozzle 110 when nozzle tip 112 contacts chamfered edge 512 at different locations. The slope of the linear relationship corresponds to the tilt β of chamfered edge 512.

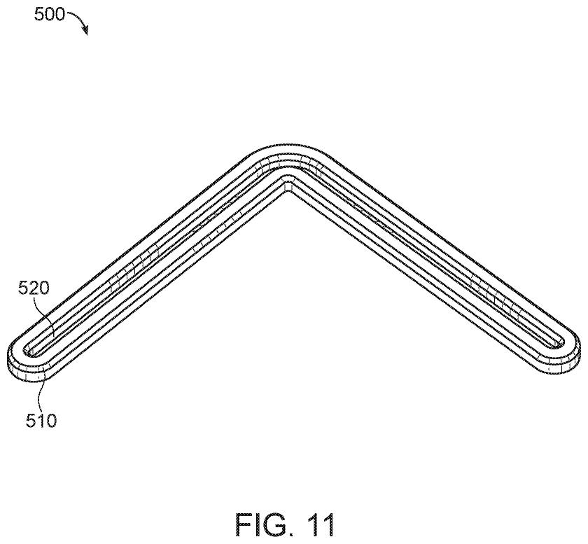

The contact of nozzle tip 112 and object 500 can cause deformation of object 500, such as deformation of the test feature. Such deformation could affect the accuracy and reliability of the detection of the vertical position of the end point 114 of nozzle 110 based on the contact between nozzle tip 112 and object 500. Therefore, in some embodiments, as shown in FIG. 11, object 500 may have a body having an extended dimension that allows nozzle tip 112 to contact different locations along the extended body of object 500 to determine the positions of different nozzles, to determine the position of a nozzle for a plurality of times, or to determine the position of a nozzle in different printing processes.

### Determination of the Horizontal Position of the End Point of a Nozzle Second Exemplary Scenario

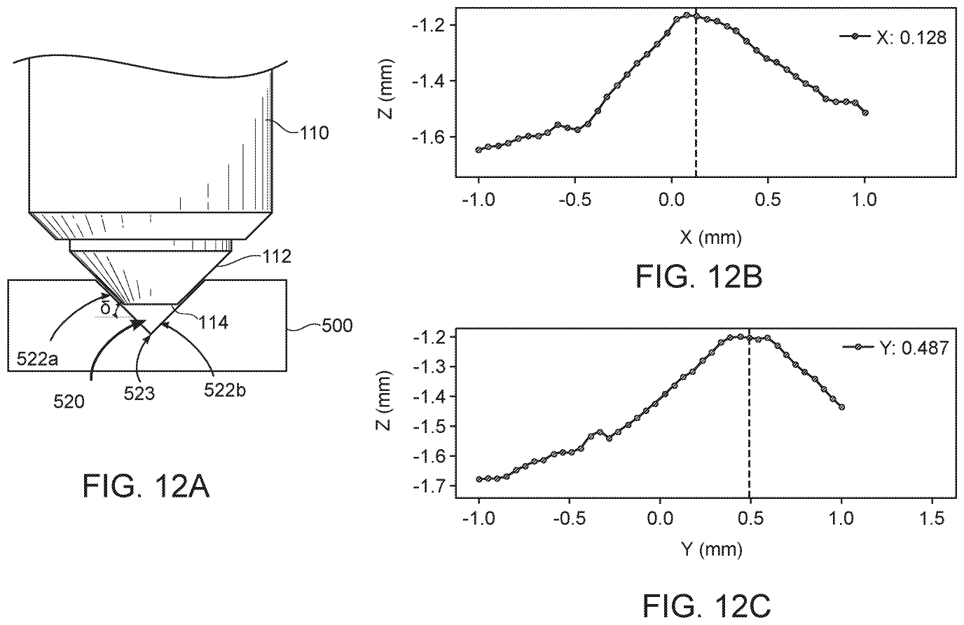

In some embodiments, a horizontal position of the end point 114 of nozzle 110 is determined based on a series of successive readings of the positions of nozzle 110 when nozzle tip 112 moves across and contacts a test feature. For example, as shown in FIG. 11, a test feature of object 500 may include a recess 520. Recess 520 has at least one slope and/or at least one edge for contacting nozzle tip 112. Exemplary embodiments of using recess 520 for determining the horizontal position of the end point 114 of nozzle 110 are described below with reference to FIGS. 12A-14C.

FIG. 12A illustrates an exemplary contact between an exemplary nozzle tip 112 and an exemplary recess 520 of an exemplary object 500, according to some embodiments of the present disclosure. As shown in FIG. 12A, recess 520 has a symmetric cross section with two slopes 522a and 522b meeting at a center point 523. In some embodiments, slopes 522a and 522b each have an angle δ substantially equal to the tilt angle α of the tapered surface of nozzle tip 112. In some embodiments, the angles of slopes 522a and 522b are about 45 degrees. When nozzle 110 is moved horizontally traversing the cross section of recess 520, the vertical position of the end point 114 when nozzle tip 112 contacts slope 522a and/or slope 522b changes with the change of the horizontal position of nozzle 110. Due to the symmetry of slopes 522a and 522b, the vertical position of the end point 114 is lowest when nozzle tip 112 is at the center of recess 520 contacting both slopes 522a and 522b, where the horizontal position of end point 114 is equal to the horizontal position of center point 523.

FIG. 12B illustrates readings of Z-axis position and X-axis position of nozzle 110 when nozzle tip 112 moves horizontally traversing the cross section of recess 520 and makes successive contacts with slope 522a or slope 522b. FIG. 12C illustrates readings of Z-axis position and Y-axis position of nozzle 110 when nozzle tip 112 moves horizontally traversing the cross section of recess 520 and makes successive contacts with slope 522a or slope 522b. As illustrated in FIGS. 12B and 12C, the reading of the Z-axis position of the nozzle 110 changes as a function of the reading of the X-axis and Y-axis positions of nozzle 110. Where the reading of the Z-axis position of nozzle 110 is the lowest (in this case, the highest negative value in FIGS. 12B and 12C), the readings of X-axis position and the Y-axis position of nozzle 110 correspond to the X-axis position and the Y-axis position of center point 523. These readings of X-axis position and the Y-axis position of nozzle 110 also correspond to the X-axis position and the Y-axis position of end point 114 when nozzle tip 112 is centered above recess 520. In this example, the X-axis position is 0.128 mm and the Y-axis position is 0.487 mm.

Recess 520 of object 500 may have any suitable cross section. In some embodiments, nozzle tip 112 has a non-symmetric shape. For example, nozzle tip 112 can have a first title angle α on one side and a second title angle α on another side. In such instances, recess 520 may have a non-symmetrical cross section. For example, slope 522a can have a first angle δ equal to the first title angle α and slope 522b can have a second angle δ equal to the second title angle α. The matching of the angles of slope 522a and 522b and the tilt angles of nozzle tip 112 allows the horizontal position of end point 114 to be equal to that of center point when nozzle tip 112 is centered above recess 520.

In some embodiments, the determined horizontal position of the end point 114 of nozzle 110 can be used as a reference point for further movements of nozzle 110. In some embodiments, a horizontal offset of nozzle 110 can be determined by comparing the determined horizontal position of the end point 114 of nozzle 110 and the position of a reference point, such as an origin at a position (0, 0). For example, in FIGS. 12B and 12C, the X-axis offset of nozzle 110 is 0.128 mm and the Y-axis offset of nozzle 110 is 0.487 mm. In some embodiments, the position of nozzle 110 in the horizontal dimension can be calibrated based on the horizontal offset of nozzle 110. In some instances, the position of nozzle 110 may be adjusted by the amount of the horizontal offset. In other instances, positioning instrument 120 or 220 may be adjusted by the amount of the horizontal offset to match its reading with the position of the end point 114 of nozzle 110.

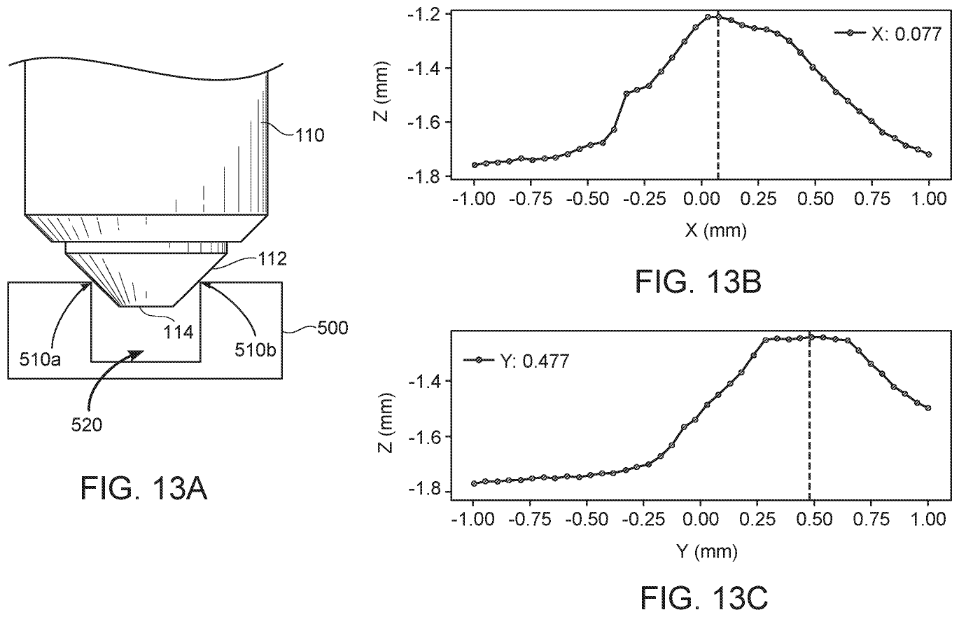

FIG. 13A illustrates an exemplary contact between an exemplary nozzle tip 112 and another exemplary recess 520 of an exemplary object 500, according to some embodiments of the present disclosure. As shown in FIG. 13A, recess 520 has a symmetric cross section with two edges 510a and 510b. When nozzle 110 is moved horizontally traversing the cross section of recess 520, the vertical position of the end point 114 when nozzle tip 112 contacts edges 510a and/or 510b changes with the change of the horizontal position of nozzle 110. Due to the symmetry of edges 510a and 510b, the vertical position of the end point 114 is lowest when nozzle tip 112 is at the center of recess 520 contacting both edges 510a and 510b, where the horizontal position of end point 114 is equal to a horizontal center position of recess 520.

FIG. 13B illustrates readings of Z-axis position and X-axis position of nozzle 110 when nozzle tip 112 moves horizontally traversing the cross section of recess 520 and makes successive contacts with edges 510a and 510b. FIG. 13C illustrates readings of Z-axis position and Y-axis position of nozzle 110 when nozzle tip 112 moves horizontally traversing the cross section of recess 520 and makes successive contacts with edges 510a and/or 510b. As illustrated in FIGS. 13B and 13C, where the reading of the Z-axis position of nozzle 110 is the lowest (in this case, the highest negative value in FIGS. 13B and 13C), the readings of X-axis position and the Y-axis position of nozzle 110 correspond to the X-axis position and the Y-axis position of end point 114 when nozzle tip 112 is centered above recess 520. In this example, the reading of the X-axis position is 0.077 mm and the Y-axis position is 0.477 mm.

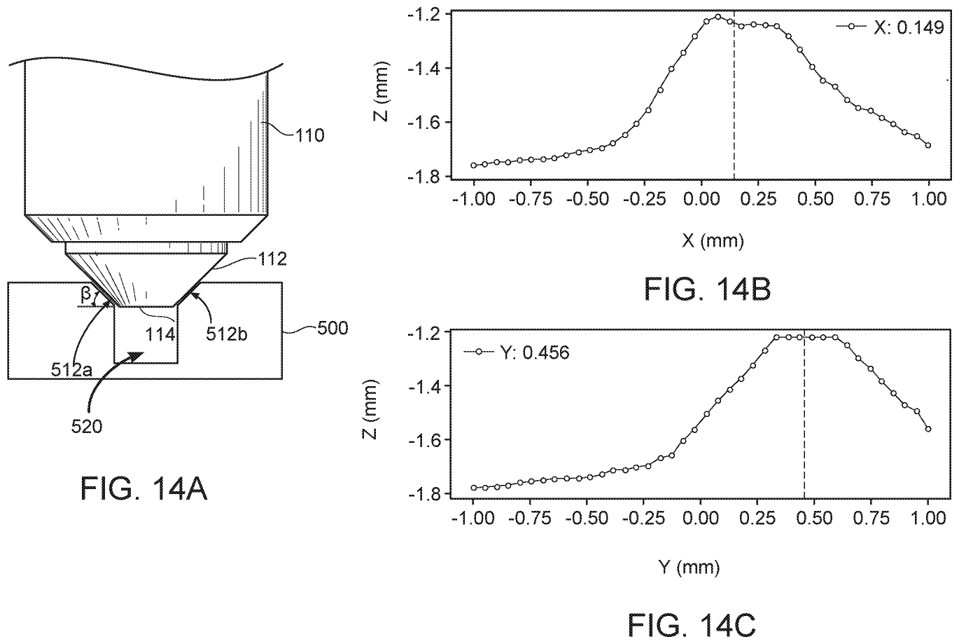

FIG. 14A illustrates an exemplary contact between an exemplary nozzle tip 112 and another exemplary recess 520 of an exemplary object 500, according to some embodiments of the present disclosure. In some embodiments, as shown in FIG. 14A, recess 520 has a symmetric cross section with two edges 512a and 512b. In some embodiments, edges 512a and 512b are chamfered edges having a sloped surface with an angle β. When nozzle 110 is moved horizontally traversing the cross section of recess 520, the vertical position of the end point 114 when nozzle tip 112 contacts edges 512a and 512b changes with the change of the horizontal position of nozzle 110. Due to the symmetry of the cross section of recess 520, the vertical position of the end point 114 is lowest when nozzle tip 112 is at the center of recess 520 contacting both edges 512a and 512b, where the horizontal position of end point 114 is equal to a horizontal center position of recess 520.

FIG. 14B illustrates readings of Z-axis position and X-axis position of nozzle 110 when nozzle tip 112 moves horizontally traversing the cross section of recess 520 and makes successive contacts with edges 512a and 512b. FIG. 14C illustrates readings of Z-axis position and Y-axis position of nozzle 110 when nozzle tip 112 moves horizontally traversing the cross section of recess 520 and makes successive contacts with edges 512a and 512b. As illustrated in FIGS. 14B and 14C, where the reading of the Z-axis position of nozzle 110 is the lowest (in this case, the highest negative value in FIGS. 14B and 14C), the readings of X-axis position and the Y-axis position of nozzle 110 correspond to the X-axis and the Y-axis position of end point 114 when nozzle tip 112 is centered above recess 520. In this example, the reading of the X-axis position is 0.149 mm and the Y-axis position is 0.487 mm.

In some embodiments, slopes 522a and 522b are not symmetrical. For example, nozzle tip 112 can have a non-symmetrical tapered shape with a first title angle α on one side and a second title angle α on another side. In such instances, recess 520 may have a non-symmetrical cross section with slope 522a can have a first angle β equal to the first title angle α and slope 522b can have a second angle β equal to the second title angle α.

In some situations, the test feature of object 500 can be deformed when nozzle tip 112 contacts the edges or slopes of the test feature. Such deformation may affect the determination of the center horizontal position of the test feature, e.g., recess 520, and thus affect the determination of the horizontal position or horizontal offset of end point 114 of nozzle 110. For example, as shown in FIGS. 12C, 13C, and 14C, multiple readings of the horizontal position of nozzle 110 correspond to the reading of the lowest vertical position of nozzle 110. This can make the determination of the center position of recess 520 inaccurate. Therefore, other methods may be used to determine the horizontal position of the end point 114 of nozzle 110 as described below.

### Determination of the Horizontal Position of the End Point of a Nozzle Third Exemplary Scenario

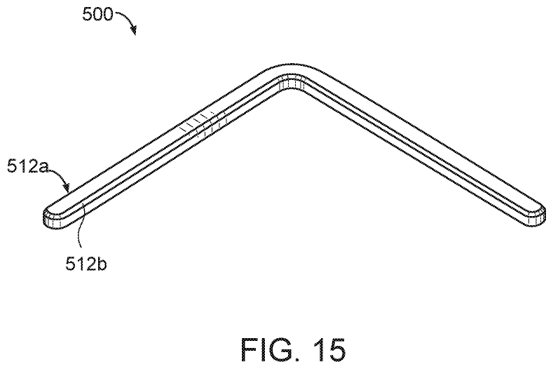

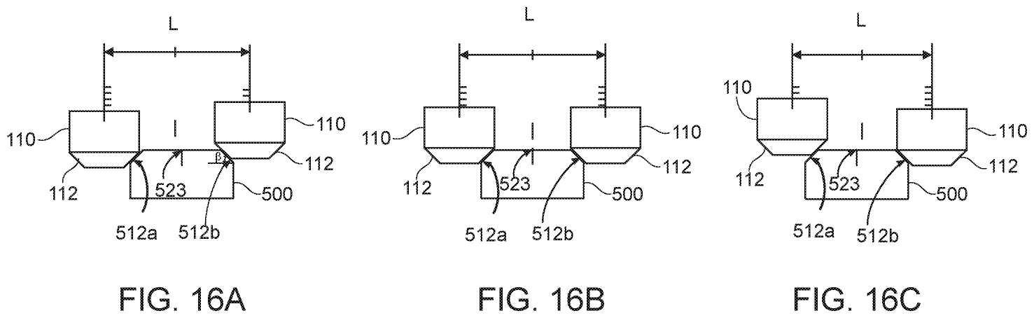

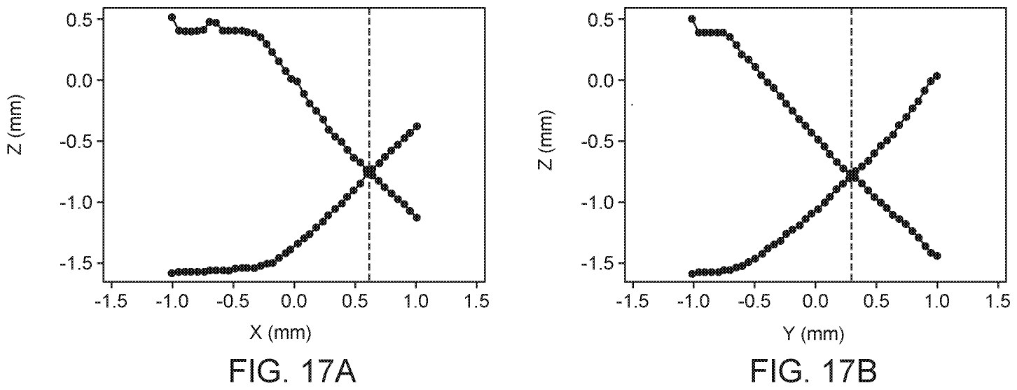

In some embodiments, to determine a horizontal position of end point 114 of nozzle 110, more than one linear relationship between the vertical position and horizontal position of the end point of nozzle 110 is obtained. The horizontal position of end point 114 of nozzle 110 can be determined based on the intersection of the linear relationships. To obtain the linear relationships, in some embodiments, a test feature of object 500 can be a protrusion having a symmetric cross section with two edges and a center point. FIG. 15 illustrate an exemplary object 500 having an extended protrusion and two edges 512a and 512b. In some embodiments, edges 512a and 512b are chamfered edges. In some embodiments, the chamfered edges has an angle β of about 45 degrees. FIGS. 16A-17B illustrate determination of two exemplary linear relationships between the vertical position and horizontal position of the end point of an exemplary nozzle.

In some embodiments, as shown in FIG. 16A, a test feature of object 500 has two edges 512a and 512b and a center point 523. When nozzle 110 moves relative to edge 512a horizontally, the vertical position of the end point 114 when nozzle tip 112 contacts edge 512a changes. Similarly, when nozzle 110 moves relative to edge 512b horizontally, the vertical position of end point 114 when nozzle tip 112 contacts edge 512b changes. Similar to the embodiments described above with reference to FIGS. 9A and 8B, two linear relationships between the vertical position and the horizontal position of end point 114 of nozzle 110 can be obtained when nozzle tip 112 makes a series of contacts with edge 512a or edge 512b respectively.

In some embodiments, as shown in FIGS. 16A-16C, nozzle 110 is moved relative to object 500 to allow nozzle tip 112 to make a series of pairs of contacts with object 500, each pair of contacts includes a contact with edge 512a and a contact with edge 512b. Each pair of contacts are made at a fixed horizontal distance apart, herein referred to as L (as shown in FIGS. 16A-16C). Thus, for each pair of contacts, two vertical positions of nozzle 110 can be obtained. When the two vertical positions of nozzle 110 of a pair of contacts are equal, as shown in FIG. 16B, the two horizontal positions of nozzle 110 of the pair of contacts are symmetric about center point 523. If the horizontal position of center point 523 is known, the horizontal position of the end point 114 of nozzle 110 can be determined based on the fixed distance L and the known position of center point 523.

FIGS. 17A and 17B illustrate an example for determining an X-axis position and a Y-axis position of end point 114 of nozzle 110 by performing pairs of contacts with edge 512a and edge 512b of object 500. As shown in FIG. 17A, for a first series of pairs of contacts with edge 512a and edge 512b at a first location on object 500, two Z-axis position readings, the Z-axis positions of nozzle 110 in both the first and second contacts of each pair of contacts, and the X-axis position of nozzle 110 of the first contact were obtained. (the X-axis position of nozzle 110 of the second contact has a fixed distance from the X-axis position of the first contact). Similarly, as shown in FIG. 17B, for a second series of pairs of contacts with edge 512a and edge 512b at a second location on object 500, two Z-axis position readings, the Z-axis positions of nozzle 110 in both the first and second contacts of each pair of contacts, and one reading of the Y-axis position of nozzle 110 of the first contact were obtained (the Y-axis position of nozzle 110 of the second contact has a fixed distance from the Y-axis position of the first contact).

For the first series of pairs of contacts, as shown in FIG. 17A, two linear relationships between the Z-axis position and the X-axis position of nozzle 110 were obtained. For the second series of contacts, as shown in FIG. 17B, two linear relationships between the Z-axis position and the Y-axis position of nozzle 110 were obtained. The intersection of the two linear relationships indicates that the two readings of the vertical position of nozzle 110 of a pair of contacts are equal, where the X-axis positions and the Y-axis positions of end point 114 of the pair of contacts are centered at center point 523 of object respectively. Thus, given the X-axis position and the Y-axis position of center point 523, the X-axis position and the Y-axis position of end point 114 of nozzle 110 can be determined. Given an X-axis position and a Y-axis position of a reference position, such as an origin (0, 0), an X-axis offset and a Y-axis offset of the end point 114 of nozzle 110 relative to the reference position can also be determined

In some embodiments, 3D printer 10 has two or more nozzles 110. Using the exemplary embodiments described above, an offset between the end points of a first nozzle and a second nozzle can be obtained. The offset can include a horizontal offset and/or a vertical offset. For example, object 500 is printed by a first nozzle of 3D printer 10. Positions of different points on object 500 correspond to the positions of the end point of the first nozzle. A point on object 500, such as the center point 523 of a test feature of object 500, can be used as a reference point. Using the test feature of object 500 according to the exemplary embodiments described above, an offset of the position of the end point of a second nozzle from the position of the reference point can be obtained. Since the position of the reference point corresponds to a position of the end point of the first nozzle, an offset between the end points of the first nozzle and the second nozzle can be obtained. Alternatively, a first relative position of the end point of a first nozzle relative to the reference point and a second relative position of the end point of a second nozzle relative to the reference point can be obtained. An offset between the end points of the first nozzle and the second nozzle can be obtained from the first and second relative positions.

As described herein, various suitable test features of object 500 may be used to derive the linear relationship between the vertical position and the horizontal position of end point 114 of nozzle 110. The dimension, angle, and/or shape of the test feature may be selected based on the shape and size of nozzle tip 112 and/or the particular printing application.

The exemplary embodiments described above may be utilized in a variety of methods for determining a position of an end point of a nozzle, for determining an offset of the position of a nozzle, for calibrating the position of the nozzle, and/or for 3D printing an object.

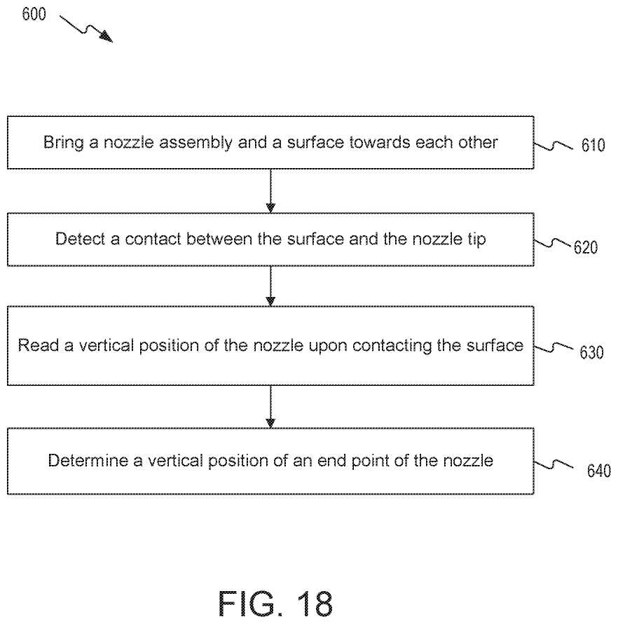

FIG. 18 is a flowchart of an exemplary method 600 for determining a position of a nozzle of a 3D printer. Method 600 uses all or a selection of features of the exemplary embodiments described above in reference to FIGS. 1-7B. In some exemplary embodiments, method 600 includes steps 610-640. Step 610 includes moving nozzle assembly 400 and a surface towards each other. In some embodiments, the surface is surface 210 of print bed 200. In some embodiments, the surface is a surface of a calibration object, such as a surface of object 500. Step 620 includes detecting a contact between the surface and nozzle tip 112. For example, step 620 may include detecting, by a sensor of nozzle assembly 400, a displacement of nozzle tip 112 upon the contact. The sensor may generate a detection signal indicative of the displacement of nozzle tip 112 and the contact between the surface and nozzle tip 112. Step 630 includes reading, by a positioning instrument, a vertical position of nozzle 110 upon contacting the surface. Step 640 includes determining the vertical position of the end point of the nozzle. For example, based on the read vertical position of the nozzle and the displacement of nozzle tip 112, the vertical position of end point 114 of nozzle 110 when it contacts the surface can be determined.

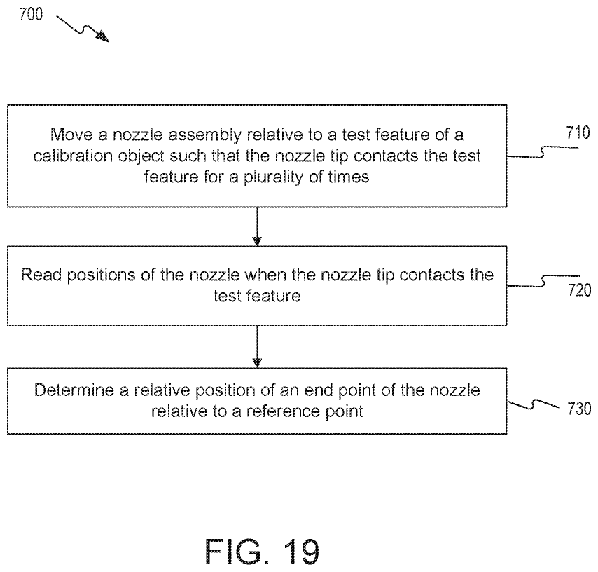

FIG. 19 is a flowchart of an exemplary method 700 for determining a position of a nozzle of a 3D printer. Method 700 uses all or a selection of features of the exemplary embodiments described above in reference to FIGS. 1-17B. In some exemplary embodiments, method 700 includes steps 710-730. Step 710 includes moving nozzle assembly 400 relative to a test feature of a calibration object such that nozzle tip 112 contacts the test feature for a plurality of times. Step 720 includes reading positions of nozzle 110 when the nozzle tip 112 contacts the test feature. In some embodiments, step 720 includes determining at least one association between the horizontal position and the vertical position of end point 114 of nozzle 110 based on the read positions. Step 730 includes determining a relative position of end point 114 of nozzle 110 relative to a reference point. The reference point may be a point of the test feature, such as center point 523 of object 500. In some embodiments, the relative position of end point 114 of nozzle 110 relative to the reference point is determined based on the at least one association.

In some embodiments, method 700 includes detecting a vertical position of end point 114 of nozzle 110 when nozzle tip 112 contacts the test feature. Method 700 may further include determining a horizontal position of end point 114 of nozzle 110 based on the detected vertical position and the determined at least one association.

In some embodiments, method 700 includes determining a relative position of end point 114 of another nozzle 110 of 3D printer 10 relative to the reference point. Method 700 includes determining a relative offset between the end points 114 of the nozzles 110 based on the determined relative positions. In some embodiments, method 700 includes calibrating a position of one of the nozzles 110 based on the relative offset.

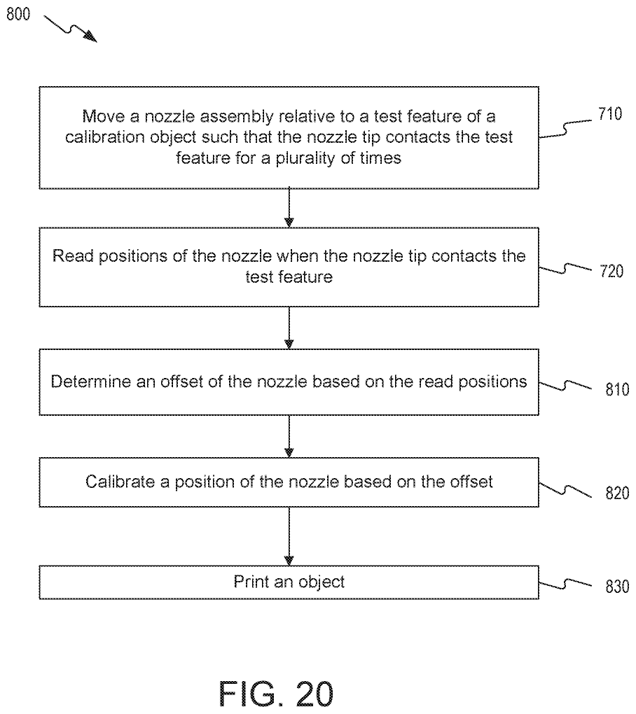

FIG. 20 is a flowchart of an exemplary method 800 for 3D printing an object. Method 800 uses all or a selection of features of the exemplary embodiments described above in reference to FIGS. 1-17B. In some exemplary embodiments, method 800 includes steps 710, 720, and 810-830. In step 810, an offset of nozzle 110 of 3D printer 10 is determined based on the read positions of nozzle 110 when nozzle tip 112 makes a plurality of contacts with the test feature of a calibration object. In some embodiments, step 810 includes determining at least one association between the horizontal position and the vertical position of end point 114 of nozzle 110 based on the read positions. In some embodiments, step 810 further includes determining an offset of end point 114 of nozzle 110 relative to a reference point based on the at least one association. Step 820 includes calibrating a position of nozzle 110 based on the offset. Step 830 includes printing an object after the calibration. In some embodiments, method 800 includes printing a calibration object before step 710.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive.

Instructions or operational steps stored by a computer-readable medium may be in the form of computer programs, program modules, or codes. As described herein, computer programs, program modules, and code based on the written description of this specification, such as those used by the controller, are readily within the purview of a software developer. The computer programs, program modules, or code can be created using a variety of programming techniques. For example, they can be designed in or by means of LabVIEW, MATLAB, Java, C, C++, assembly language, or any other suitable programming languages. One or more of such programs, modules, or code can be integrated into a device or existing communications software. The programs, modules, or code can also be implemented or replicated as firmware or circuit logic.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A nozzle assembly for depositing a material for forming an object, comprising:
a nozzle having a nozzle tip to deposit the material; and
a sensor at least partially attached to the nozzle;
wherein the sensor is configured to detect a contact between the nozzle tip and a surface.

2. The print head of claim 1, wherein the sensor is configured to generate a detection signal indicative of the contact between the nozzle tip and the surface.

3. The print head of claim 1, wherein the sensor comprises a resilient member attached to the nozzle and configured to allow the nozzle to deflect from the surface upon contacting the surface.

4. The print head of claim 2, wherein the sensor further comprises a magnet and a magnetic encoder.

5. The print head of claim 2, wherein the sensor further comprises a mechanical, optical, electrical, or magnetic switch.

6. The print head of claim 2, wherein the sensor comprises a force sensor or an electrical conductivity sensor.

7. The print head of claim 1, wherein the nozzle tip has a tapered surface.

8. The print head of claim 7, wherein the tapered surface has a tilt angle of about 45 degrees.

9. The print head of claim 7, wherein the nozzle tip has a truncated cone shape.

10. The print head of claim 1, wherein the surface is the surface of a print bed of a 3D printer or an upper surface of an object.

11. A print head for a 3D printer, comprising:
a nozzle assembly for depositing a material for forming an object, comprising
a nozzle having a nozzle tip to deposit the material; and
a sensor at least partially attached to the nozzle;
wherein the sensor is configured to detect a contact between the nozzle tip and a surface.

12. A 3D printer, comprising:
a print bed;
a print head comprising:
at least one nozzle assembly for depositing a material for forming an object, comprising a nozzle having a nozzle tip to deposit a material and a sensor at least partially attached to the nozzle, wherein the sensor is configured to detect a contact between the nozzle tip and a surface; and
a positioning instrument configured to move the print head and the print bed relative to each other vertically and/or horizontally.

13. A method for determining a position of a nozzle of a 3D printer, the method comprising:
moving a nozzle assembly and a surface relative to each other, the nozzle assembly comprising the nozzle and a sensor at least partially attached to the nozzle, the nozzle comprising a nozzle tip;
detecting, by the sensor, a contact between the surface and the nozzle tip;
reading, by a positioning instrument, a vertical position of the nozzle upon contacting the surface; and
determining a vertical position of an end point of the nozzle.

14. The method of claim 13, wherein detecting the contact between the surface and the nozzle comprises detecting a displacement of the nozzle tip.

15. The method of claim 14, further comprising determining the vertical position of the end point of the nozzle based on the read vertical position of the nozzle and the displacement of the nozzle tip.

16. A method for determining a position of a nozzle of a 3D printer, the method comprising:
moving a nozzle assembly relative to a test feature of a calibration object such that a nozzle tip contacts the test feature for a plurality of times, the nozzle assembly comprising the nozzle that has the nozzle tip;
reading positions of the nozzle when the nozzle tip contacts the test feature; and
determining a relative position of an end point of the nozzle relative to a reference point.

17. The method of claim 16, wherein the nozzle assembly further comprises a sensor at least partially attached to the nozzle.

18. The method of claim 16, further comprising determining at least one association between the horizontal position and the vertical position of the end point of the nozzle based on the read positions of the nozzle.

19. The method of claim 18, further comprising detecting a vertical position of the end point of the nozzle when the nozzle tip contacts the test feature.

20. The method of claim 19, further comprising determining a horizontal position of the end point of the nozzle based on the detected vertical position and the at least one association.

21. The method of claim 18, further comprising determining the relative position of the end point of the nozzle relative to the reference point based on the at least one association.

22. The method of claim 16, further comprising determining a relative position of an end point of another nozzle of the 3D printer relative to the reference point.

23. The method of claim 22, further comprising determining a relative offset between the end points of the nozzles based on the relative positions.

24. The method of claim 16, further comprising calibrating a position of one of the nozzles based on the relative offset.

25. The method of claim 16, wherein the reference point is a geometric center of the test feature.

26. The method of claim 16, wherein the nozzle tip has a symmetric shape.

27. The method of claim 16, wherein the test feature comprises at least one edge.

28. The method of claim 16, wherein the test feature comprises at least one slope.

29. The method of claim 16, wherein the test feature has a symmetric cross section.

30. The method of claim 16, wherein the test feature comprises a recess.

31. The method of claim 16, wherein the test feature comprises a protrusion.

32. A method for 3D printing an object, comprising
determining an offset of a nozzle having a nozzle tip, comprising
moving the nozzle assembly relative to a test feature of a calibration object such that the nozzle tip contacts the test feature for a plurality of times, the nozzle assembly comprising the nozzle;
reading positions of the nozzle when the nozzle tip contacts the test feature; and
determining the offset of the nozzle based on the read positions;
calibrating a position of the nozzle based on the offset; and
printing the object.
